(19) United States
(12) Patent Application Publication
(10) Pub. No.: US 2016/0224738 A1
(43) Pub. Date: Aug. 4, 2016

(54) System, Method and Software for Predicting Drug Efficacy in a Patient

(71) Applicant: PATHWAY PHARMACEUTICALS LTD, Wan Chai (HK)

(72) Inventors: ALEXANDER ZHAVORONKOV, MOSCOW (RU); KSENIA LEZHNINA, PYATIGORSK (RU); MIKHAIL KORZINKIN, MOSCOW (RU); DENIS SHEPELIN, BIYSK (RU); ARTEM ARTEMOV, MOSCOW (RU); ALEXANDER ALIPER, RAMENSKOYE (RU); ANTON BUZDIN, MOSCOW (RU)

(21) Appl. No.: 15/008,465

(22) Filed: Jan. 28, 2016

Related U.S. Application Data
(60) Provisional application No. 62/109,258, filed on Jan. 29, 2015.

(51) Int. Cl. G06F 19/00

(52) U.S. Cl. CPC G06F 19/345

(57) ABSTRACT

The present invention provides systems, methods and software predicting a clinical outcome of a patient having a disorder the method including the steps of providing a drug score database (DSD) based on pathway activation strengths (PASs) for a plurality of biological pathways associated with the drug in the treatment of the disorder and comparing the pathway activation strengths of the plurality of biological pathways of the patient with the drug score database to provide a predictive indication if the patient is a responder or non-responder to the drug; and repeating these steps for a plurality of drugs thereby predicting a clinical outcome to the plurality of drugs of the patient to the disorder.

### FIELD OF THE INVENTION

The present invention relates generally to systems and methods of analysis of molecular pathways, and more specifically to systems and methods for making drug efficacy prediction.

### BACKGROUND OF THE INVENTION

In the twentieth century, enormous studies were made in combatting infectious diseases, in their detection and drugs to treat them. The major problem in the medical world has thus shifted from treating acute diseases to treating chronic diseases. Over the last few decades, with the advent of genetic engineering, much research and funding has been invested in genomics and gene-based personalized medicine. A need has arisen to develop diagnostic tools for use in the characterization of personalized aspects of chronic diseases.

There are many known molecular pathways in a mammalian body. The molecular pathways include signaling pathways, metabolic pathways and others.

Intracellular signaling pathways (SPs) regulate numerous processes involved in normal and pathological conditions including development, growth, aging and cancer. Many bioinformatic tools have been developed, which analyze SPs.

The information relating to signaling pathway activation (SPA) can be obtained from the massive proteomic or transcriptomic data. Although the proteomic level may be somewhat closer to the biological function of SPA, the transcriptomic level of studies today is far more feasible in terms of performing experimental tests and analyzing the data.

US2008254497A provides a method of determining whether tumor cells or tissue is responsive to treatment with an ErbB pathway-specific drug. In accordance with the invention, measurements are made on such cells or tissues to determine values for total ErbB receptors of one or more types, ErbB receptor dimers of one or more types and their phosphorylation states, and/or one or more ErbB signaling pathway effector proteins and their phosphorylation states. These quantities, or a response index based on them, are positively or negatively correlated with cell or tissue responsiveness to treatment with an ErbB pathway-specific drug. In one aspect, such correlations are determined from a model of the mechanism of action of a ErbB pathway-specific drug on an ErbB pathway. Preferably, methods of the invention are implemented by using sets of binding compounds having releasable molecular tags that are specific for multiple components of one or more complexes formed in ErbB pathway activation. After binding, molecular tags are released and separated from the assay mixture for analysis.

U.S. Pat. No. 8,623,592 discloses methods for treating patients which methods comprise methods for predicting responses of cells, such as tumor cells, to treatment with therapeutic agents. These methods involve measuring, in a sample of the cells, levels of one or more components of a cellular network and then computing a Network Activation State (NAS) or a Network Inhibition State (NIS) for the cells using a computational model of the cellular network. The response of the cells to treatment is then predicted based on the NAS or NIS value that has been computed. The invention also comprises predictive methods for cellular responsiveness in which computation of a NAS or NIS value for the cells (e.g., tumor cells) is combined with use of a statistical classification algorithm Biomarkers for predicting responsiveness to treatment with a therapeutic agent that targets a component within the ErbB signaling pathway are also provided.

Cancer drugs are extremely expensive and should not be given to patients who will not respond thereto. There thus remains a need for systems and methods, which can predict drug efficacy in a patient.

### SUMMARY OF THE INVENTION

Some of the objects of the present invention are to provide novel systems and methods for predicting drug efficacy in a patient.

Some further objects of the present invention are to provide novel systems and methods for predicting drug combination efficacy in a patient.

It is an object of some aspects of the present invention to provide systems and methods, which use historic patient databases to predict drug efficacy in a patient.

It is a further object of some aspects of the present invention to provide systems and methods, which provide statistical predictions to provide an indication if a drug is likely to be effective in a patient.

It is another further object of some aspects of the present invention to provide systems and methods, which provide a medical practitioner with a decision on drug treatment economy for a specific patient, which saves the use of the drug in the case where the patient is statistically likely not to respond to the drug.

The present invention provides systems, methods and software predicting a clinical outcome of a patient having a disease or disorder, the method including the steps of providing a drug score database (DSD) based on pathway activation strengths (PASs) for a plurality of biological pathways associated with the drug in the treatment of the disorder and comparing the pathway activation strengths of the plurality of biological pathways of the patient with the drug score database to provide a predictive indication if the patient is a responder or non-responder to the drug; and repeating these steps for a plurality of drugs thereby predicting a clinical outcome to the plurality of drugs of the patient to the disorder.

The biological or molecular pathways include signaling pathways, metabolic pathways and others.

There is thus provided according to an embodiment of the present invention, a method for providing a drug efficacy prediction system, the method including:
i. providing a processor adapted to activate a computer-readable medium in which program instructions are stored, which instructions, when read by a computer, cause the processor to activate a drug score database (DSD) based on pathway activation strengths (PASs) for a plurality of biological pathways associated with a drug in the treatment of a disorder in a patient; and
ii. comparing the pathway activation strengths of the plurality of biological pathways of the patient with the drug score database thereby providing an efficacy prediction of the drug in the patient.

Some further embodiments of the present invention provide a method and system for prediction of the clinical efficacy of anticancer therapies for treatment of patients with breast cancer using BreastCancerTreatment module of the OncoFinder tool. BreastCancerTreatment uses OncoFinder databases of signaling and metabolic pathways. It provides the probability of being a responder/a non-responder for an individual patient on the basis of a combination of marker signaling and marker metabolic pathways activation/inhibition.

There is thus provided according to an embodiment of the present invention, a method for predicting a clinical outcome of a patient having a disorder, the method comprising:
i. providing a drug score database (DSD) based on pathway activation strengths (PASs) for a plurality of biological pathways associated with the drug in the treatment of the disorder; and
ii. comparing the pathway activation strengths of the plurality of biological pathways of the patient with the drug score database to provide a predictive indication if the patient is a responder or non-responder to the drug;
iii. repeating the above steps for a plurality of drugs thereby predicting a clinical outcome to the plurality of drugs of the patient to the disorder.

According to an embodiment of the present invention, the providing a drug score database (DSD) step comprises:
i. obtaining proliferative bodily samples and healthy bodily samples from patients;
ii. applying said drug to said patients;
iii. determining responder and non-responder patients to said drug; and
iv. repeating steps i to iii for said plurality of drugs.

According to another embodiment of the present invention, the determining step comprises comparing gene expression in at least one of a signaling pathway and a metabolic pathway.

Furthermore, according to an embodiment of the present invention, the determining step includes comparing gene expression in selected signaling pathways.

Further, according to an embodiment of the present invention, the selected signaling pathways are associated with the drug.

Yet further, according to an embodiment of the present invention, the determining step further includes determining a drug score at least one pathway activation strength (PAS) value for each pathway in the responder and the non-responder patients.

Moreover, according to an embodiment of the present invention, the determining step further includes determining a drug score for the drug based on the at least one pathway activation strength (PAS) value.

Additionally, according to an embodiment of the present invention, the bodily samples are selected from the group consisting of a tissue sample, a cell culture, an individual single cell, a bodily sample, an organism sample and a microorganism sample.

According to an embodiment of the present invention, the biological pathways are signaling pathways.

Further, according to an embodiment of the present invention, the biological pathways are metabolic pathways.

Moreover, according to an embodiment of the present invention, the gene expression includes quantifying expression of plurality of gene products.

Additionally, according to an embodiment of the present invention the gene products includes a set of at least five gene products.

Furthermore, according to an embodiment of the present invention, the method further includes calculating a pathway activation strength (PAS), indicative of the pathway activation of each of the biological pathways.

Additionally, according to an embodiment of the present invention, the calculating step includes adding concentrations of the set of the at least five gene products of the sample and comparing to a same set in the at least one control sample.

Furthermore, according to an embodiment of the present invention, the gene products provide at least one function in the biological pathway.

Further, according to an embodiment of the present invention, the at least one function includes an activation function and a suppressor function.

Yet further, according to an embodiment of the present invention, the at least one function includes an up-regulating function and a down-regulating function.

Additionally, according to an embodiment of the present invention, the determining step includes at least one of profiling gene expression, RNA profiling, RNA sequencing, DNA profiling, DNA sequencing, protein profiling, amino acid sequencing, at least one immunochemical methodology, a mass spectrometry analysis, a microarray technology, a quantitative PCR methodology and combinations thereof.

Additionally, according to an embodiment of the present invention, the method is quantitative.

Additionally or alternatively, the method is qualitative.

Furthermore, according to an embodiment of the present invention the patients are sick.

Additionally, according to an embodiment of the present invention, the sick subject suffers from a proliferative disease or disorder.

Moreover, according to an embodiment of the present invention, the proliferative disease or disorder is cancer.

Additionally, according to an embodiment of the present invention, the proliferative disease or disorder is breast cancer.

Moreover, according to an embodiment of the present invention, the pathway is selected from the group consisting of a Caspase Cascade pathway; a CREB pathway; a GPCR pathway; a CSK3 pathway; an HIF1Alpha pathway; an HIF1Alpha Pathway VEGF pathway; an ILK pathway; an IP3 pathway; a PPAR pathway; a VEGF pathway; and combinations thereof.

There is thus provided according to another embodiment of the present invention, a computer software product, the product configured for predicting drug efficacy for treating a disorder in a patient, the product including a computer-readable medium in which program instructions are stored, which instructions, when read by a computer, cause the computer to;
a. provide a drug score database (DSD) based on pathway activation strengths (PASs) for a plurality of biological pathways associated with the drug in the treatment of the disorder; and
b. compare said pathway activation strengths of said plurality of biological pathways of said patient with said drug score database to provide a predictive indication if said patient is a responder or non-responder to said drug;
c. repeat steps i) and ii) for a plurality of drugs thereby predicting a clinical outcome to said plurality of drugs of said patient to said disorder.

There is thus provided according to an additional embodiment of the present invention, a system for predicting drug efficacy for treating a disorder in a patient the system including;

a. a processor adapted to activate a computer-readable medium in which program instructions are stored, which instructions, when read by a computer, cause the processor to:
i. provide a drug score database (DSD) based on pathway activation strengths (PASs) for a plurality of biological pathways associated with the drug in the treatment of the disorder; and
ii. compare said pathway activation strengths of said plurality of biological pathways of said patient with said drug score database to provide a predictive indication if said patient is a responder or non-responder to said drug;
iii. repeat steps i) and ii) for a plurality of drugs thereby predicting a clinical outcome to said plurality of drugs of said patient to said disorder;

b. a memory for storing said drug score database (DSD); and

c. a display for displaying data associated with said predictive clinical outcome of said patient.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic illustration of a system for predicting drug efficacy in a patient, in accordance with an embodiment of the present invention;

FIG. 2 is a simplified flowchart of a method for determining activation to mitosis conversion factors (AMCFs), in accordance with an embodiment of the present invention;

FIG. 3 is a simplified flowchart of a method for determining predicting drug efficacy in a patient, in accordance with an embodiment of the present invention;

FIG. 4 is a simplified flowchart of a method for predicting drug efficacy in a patient, in accordance with an embodiment of the present invention;

FIG. 5 is a graph of density of normally distributed x values.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

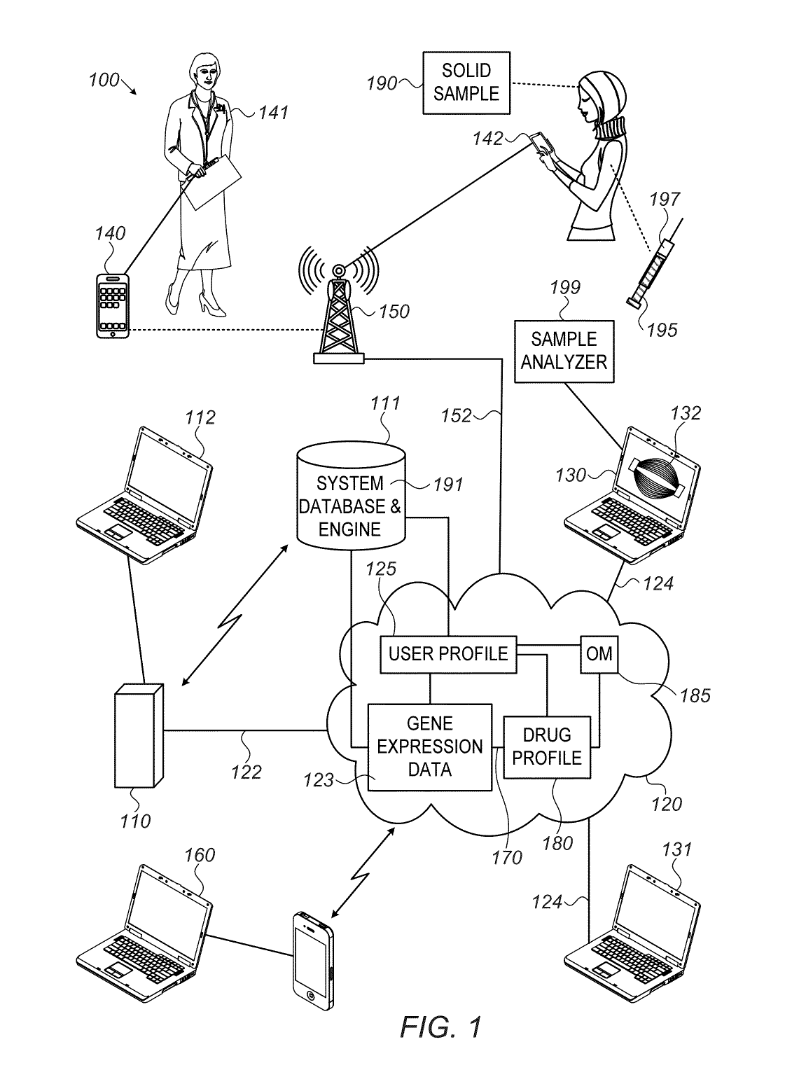

Reference is now made to FIG. 1, which is a simplified schematic illustration of a system for predicting drug efficacy in a patient, in accordance with an embodiment of the present invention.

System 100 typically includes a server utility 110, which may include one or a plurality of servers and one or more control computer terminals 112 for programming, trouble-shooting servicing and other functions. Server utility 110 includes a system engine 111 and database, 191. Database 191 comprises a user profile database 125, a pathway cloud database 123 and a drug profile database 180.

Depending on the capabilities of a mobile device, system 100 may also be incorporated on a mobile device that synchronizes data with a cloud-based platform.

The drug profile database comprises data relating to a large number of drugs for controlling and treating cancer. For each type of drug, the dosage values, pharmo-kinetic data and profile, pharmodynamic data and profiles are included.

The drug profile database further comprises data of drug combinations, including dosage values pharmo-kinetic data and profile, pharmodynamic data and profiles.

A medical professional, research personnel or patient assistant/helper/carer 141 is connected via his/her mobile device 140 to server utility 110. The patient, subject or child 143 is also connected via his/her mobile device 142 to server utility 110. In some cases, the subject may be a mammalian subject, such as a mouse, rat, hamster, monkey, cat or dog, used in research and development. In other cases, the subject may be a vertebrate subject, such as a frog, fish or lizard. The patient or child's is monitored using a sample analyzer 199. Sample analyzer 199, may be associated with one or more computers 130 and with server utility 110. Computer 130 and/or sample analyzer 199 may have software therein for predicting drug efficacy in a patient, as will be described in further details hereinbelow.

Typically, gene expression data 123 (FIG. 1), generated by the software of the present invention, is stored locally and/or in cloud 120 and/or on server 110.

The sample analyzer may be constructed and configured to receive a solid sample 190, such as a biopsy, a hair sample or other solid sample from patient 143, and/or a liquid sample 195, such as, but not limited to, urine, blood or saliva sample. The sample may be extracted by any suitable means, such as by a syringe 197.

The patient, subject or child 143 may be provided with a drug (not shown) by health professional/research/doctor 141.

System 100 further comprises an outputting module 185 for outputting data from the database via tweets, emails, voicemails and computer-generated spoken messages to the user, carers or doctors, via the Internet 120 (constituting a computer network), SMS, Instant Messaging, Fax through link 122.

Users, patients, health care professionals or customers 141, 143 may communicate with server 110 through a plurality of user computers 130, 131, or user devices 140, 142, which may be mainframe computers with terminals that permit individual to access a network, personal computers, portable computers, small hand-held computers and other, that are linked to the Internet 120 through a plurality of links 124. The Internet link of each of computers 130, 131, may be direct through a landline or a wireless line, or may be indirect, for example through an intranet that is linked through an appropriate server to the Internet. System 100 may also operate through communication protocols between computers over the Internet which technique is known to a person versed in the art and will not be elaborated herein.

Users may also communicate with the system through portable communication devices such as mobile phones 140, communicating with the Internet through a corresponding communication system (e.g. cellular system) 150 connectable to the Internet through link 152. As will readily be appreciated, this is a very simplified description, although the details should be clear to the artisan. Also, it should be noted that the invention is not limited to the user-associated communication devices—computers and portable and mobile communication devices—and a variety of others such as an interactive television system may also be used.

The system 100 also typically includes at least one call and/or user support and/or tele-health center 160. The service center typically provides both on-line and off-line services to users. The server system 110 is configured according to the invention to carry out the methods of the present invention described herein.

It should be understood that many variations to system 100 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet. Future devices for communications via new communication networks are also deemed to be part of system 100. Memories may be on a physical server and/or in a virtual cloud.

A mobile computing device may also embody a non-synced or offline copy of memories, copies of pathway cloud data, user profiles database, drug profiles database and execute the system, engine locally.

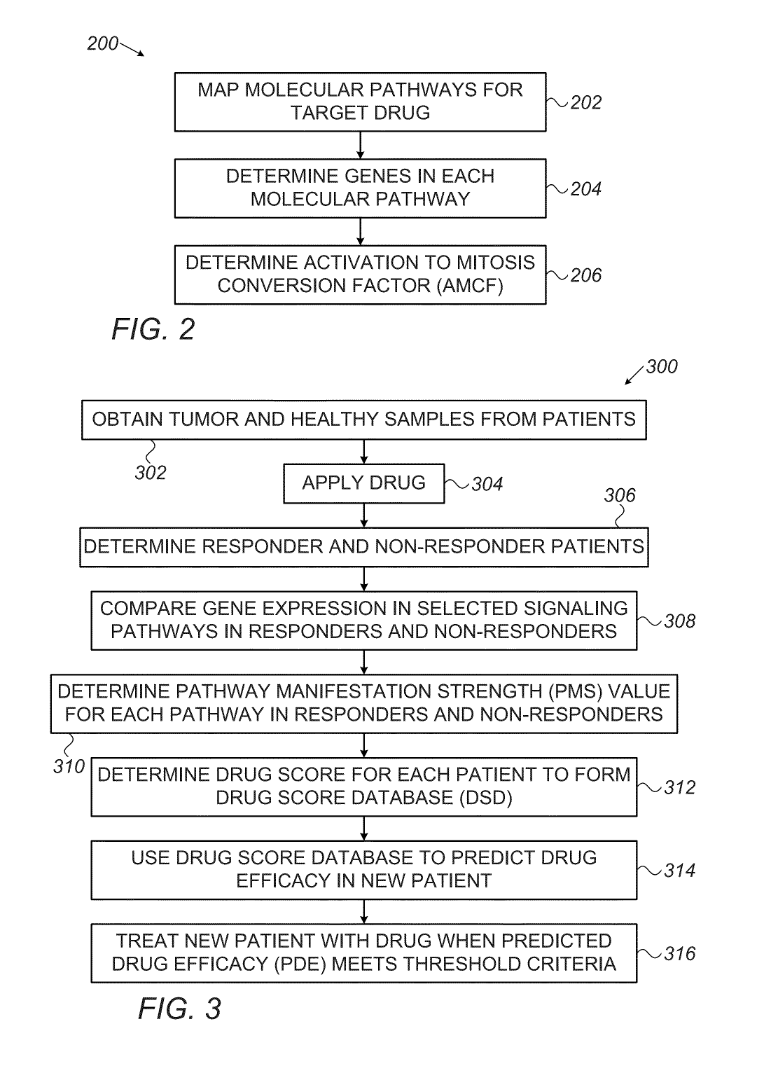

Reference is now made to FIG. 2, which is simplified flowchart of a method for determining activation to mitosis conversion factors (AMCFs), in accordance with an embodiment of the present invention.

There are three basic steps for determining activation to mitosis conversion factors (AMCFs). First, a mapping step 202 is performed to map molecular pathways for a target drug. Thereafter, the genes in each molecular pathway are defined in a gene determining step 204. Thereafter, the activation to mitosis conversion factor (AMCF) is determined in an AMCF determining step 206.

FIG. 3 is a simplified flowchart 300 of a method for determining predicting drug efficacy in a patient, in accordance with an embodiment of the present invention.

In a first obtaining step 302, bodily samples are collected from healthy and sick (tumor samples) patients and are stored (such as by refrigeration or freezing).

In an applying drug step 304, a potential drug is applied to the samples in vitro.

In an evaluating step 306, the responder and non-responder samples to the drug are defined.

Thereafter, in a gene expression definition step 308, the gene expression of the responder and non-responder populations are compared.

Thereafter, in a determining pathway manifestation strength (PMS) for each pathway in responders and non-responders is determined in a PMS determining step 310.

In a determining drug score for each patient step 312, the drug scores based on the previous steps are calculated for each patient. The patient drug scores are used to form a drug score database.

Thereafter, the drug score database can be used for each new patient in a prediction step 314 to predict a new patient drug score. A patient will not be treated with the drug if he/she is predicted to be a non-responder but will be treated with the drug if he/she is predicted to be a responder.

A primary object of the present invention is to provide a prediction of the clinical efficacy of anticancer therapies for treatment of patients with breast cancer using BreastCancerTreatment module of the OncoFinder tool. BreastCancerTreatment uses OncoFinder databases of signaling and metabolic pathways. It provides the probability of being a responder/a non-responder for an individual patient on the basis of a combination of marker signaling and marker metabolic pathways activation/inhibition.

OncoFinder

OncoFinder system designed to advise oncologists conducting treatment of patients with malignant tumors. This computer system is a knowledge base that is used to support decisions regarding treatment of individual cancer patients by targeted anticancer drugs—monoclonal antibodies (mabs), kinase inhibitors (nibs), some hormones and stimulants. OncoFinder knowledgebase operates basic data, which are the results of microarray analysis of the transcriptome cell biopsy as malignant tumors and healthy tissue of similar organs. Result of the system is evaluation of the degree of pathological changes in the pro- and anti-mitotic molecular pathways and the ability of targeted anticancer drugs to compensate for these changes.

This information can be used to forecast the clinical efficacy of drugs for individual patients with cancer and/or hematologic lesion. The OncoFinder system's knowledgebase based on database of targeted anticancer drugs and pro- and anti-mitotic molecular pathways, which contains information about the interaction of proteins and their corresponding genes. The system is implemented in the form of a cloud online software on “Amazon” web platform at http://aws.amazon.com/.

When calculating the quantitative indicators of pathological changes in pro and anti-mitotic signaling pathways for individual cancer patients, as well as the ability of anticancer drugs to compensate for these changes, OncoFinder system uses the following assumptions. First, graph of protein-protein interactions in each signaling pathway is considered as two parallel chains of events: one leads to activation of signaling pathways, other—to inhibition of this pathway. Second, the expression level of signal transducer protein in each pathway is considered in dormant state much smaller than in activation state (thereby each signal transducer protein in dormant state has deeply unsaturated state).

Thus, the OncoFinder system considers signal transducer protein of each pathway as having equal opportunities cause the activation/inhibition of pathway. Under these assumptions, based on the law of mass action next assessment of pathological changes in the signal pathway (signal outcome, SO) can be proposed,

$$S O = \frac{{\prod }_{i = 1}^{N} [ AGEL ] i}{{\prod }_{j = 1}^{M} [ RGEL ] j}$$

In this equation the multiplication is performed over all the genes of activators and inhibitors of the signal present in the pathway, [AGEL]i (activator gene expression level) and [RGEL]j (repressor gene expression level) are expression level of activators gene No i and No j, correspondingly.

The logarithm for the transition from multiplicative value to additive relative mitogenic significance of cascade (pathway mitogenic strength), which serves to evaluate the degree of pathological changes in the signal pathway:

PAS=AMCFp*ΣₙNIInp*ARRnp*BTIFn*lg(CNRn)

Here CNRn (cancer (case)-to-normal ratio) is the ratio of expression levels of a gene, encoding a protein n, from individual patient to norm (mean value of the control group). Discrete value BTIF (beyond tolerance interval flag) is calculated as:

$$B T I F = \{ \begin{matrix}0 , & CNRn lays within the tolerance interval \\ 1 , & CNRn lays outside the tolerance interval\end{matrix}$$

Discrete value ARR (activator/repressor role) is defined as follows and stored in the database mitogenetic pathways:

$$A R R = \{ \begin{matrix}- 1 , & protein n is the repressor of the pathway p \\ - 0.5 , & protein n is rather repressor of the pathway p \\ 0 , & \begin{matrix}protein n is neither repressor nor \\ activator of the pathway p\end{matrix} \\ 0.5 , & protein n is rather activator of the pathway p \\ 1 , & protein n is the activator of the pathway p\end{matrix}$$

Discrete value AMCF (activation-to-mitosis conversion factor):

$$A M C F = \{ \begin{matrix}- 1 , & activation prevents mitosis \\ 1 , & activation activates mitosis\end{matrix}$$

Discrete value node involvement index:

$$N I I = \{ \begin{matrix}0 , & there is no protein t in the pathway p \\ 1 , & there is protein t in the pathway p\end{matrix}$$

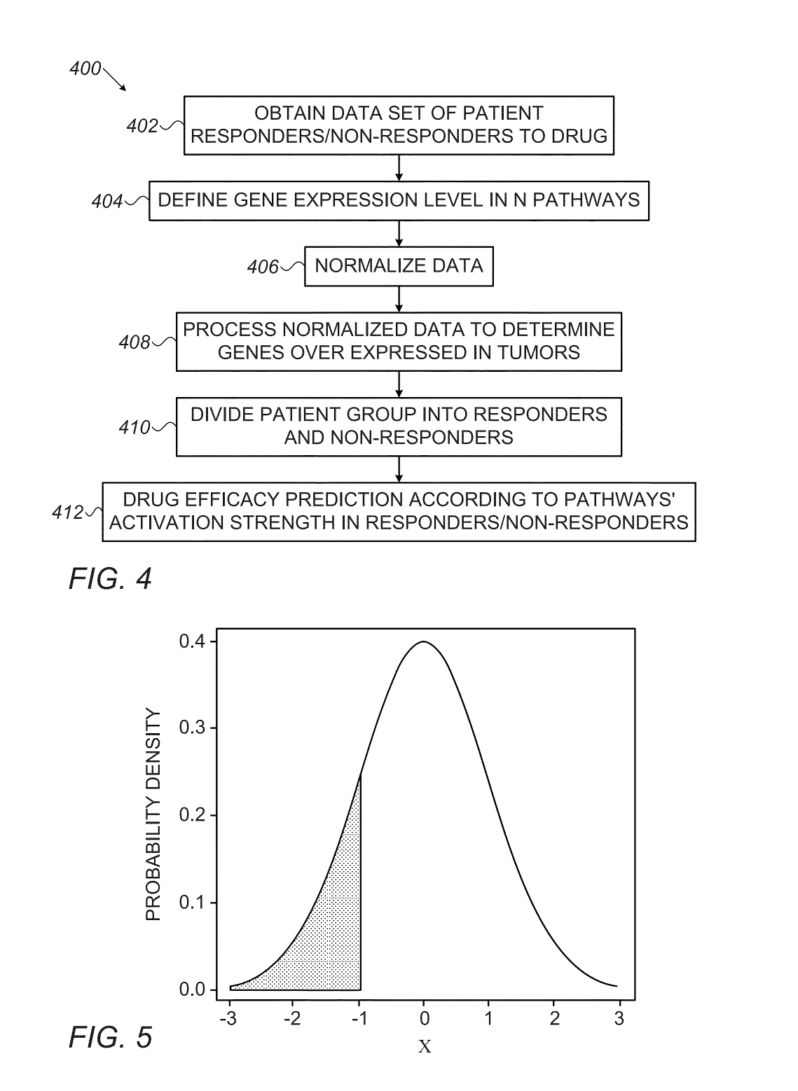

Reference is now made to FIG. 4, which is a simplified flowchart 400 of a method for predicting drug efficacy in a patient, in accordance with an embodiment of the present invention.

In a first data obtaining step 402 data is obtained relating to patient responders/non-responders to one or more drugs. Data preparation and analysis—for example, datasets expression files were downloaded from Gene Expression Omnibus (GEO) database available online at www.ncbi.nlm nih.gov/geo/. All datasets were required to have information about clinical response of patients to anticancer therapy such as complete response, partial response, no response, stable disease, progressive disease etc. Samples failed to provide this information were excluded from further analyses.

For each dataset, a table of gene expression profiles of tumor and normal samples is built in a gene expression profile definition step 404, using any one or more suitable mathematical tool, such as by R and Bioconductor (www.bioconductor.org/).

In a normalizing data step 406, the gene expression profile data from the profile definition step 404 is normalized.

Thereafter, the normalized gene profile data is inputted into the OncoFinder tool in a data processing step 408. The data is processed using, for example, default OncoFinder parameters: Sigma=2, CNR (cancer/normal ratio of gene expression level) lower limit=0.67, CNR upper limit=1.5. These parameters are used to determine differentially expressed genes in tumor samples compared to normal samples.

OncoFinder algorithm:

counts CNRs to all genes and determines differentially expressed genes

evaluates the degree of pathological changes in the signaling pathways (PAS)

evaluates the degree of pathological changes in the metabolic pathways (PAS)

Thereafter in a patient dividing step 410, all samples of patients are divided into two groups: responders and non-responders according to given information in datasets description.

In a drug efficacy predication step 412, the PAS values of responders to PAS values of non-responders are compared. R is used to count correlation test and AUC values. Thresholds for p-value of correlation test and AUC values were p-value<=0.05 and AUC>=0.7. Pathways which pass threshold filters are called marker pathways that significantly differ in responders in comparison to non-responders samples. These marker pathways are used to predict the effectiveness of each drug (such as an anticancer therapy) for each sample in chosen datasets.

Probability

Assumption: PAS values of a signaling and metabolic pathways are normally distributed.

Probability (P) is built as a cumulative density function or distribution function. It returns the area below the given value of “x” or for x=−1, the shaded region in FIG. 5. If the given value of “x” >=mean then probability is built as (1−P). Thus, the range of probability is 0 to 0.5.

ResponseScore

At this stage, probabilities of being a responder and a non-responder are built for all patients for all marker pathways separately. To arrive to a decision if a patient is a responder or non-responder the ResponseScore is counted.

$$ResponseScore = \frac{Number of marker pathways [ P ( responder ) > P ( non \text{-} responder ) ]}{( Number of all marker pathways )}$$

P (responder)—probability of being a responder, P (non-responder)—probability of being a non-responder.

If ResponseScore>0.5 a patient is considered to be a responder, otherwise a non-responder.

Drug (also termed herein Response Score) score data for provided examples are in supplementary materials.

To improve the prediction power PAS values of marker metabolic pathways were included to analyses (Table 2).

### EXAMPLES

The description for methods of prediction of drug efficacy in a responder/non-responder patient shown in FIGS. 3-4 are used to in the examples hereinbelow for various non-limiting examples.

### Example 1

Effect of Glutathione S-transferase P1 (GSTP1) expression on resistance to neoadjuvant paclitaxel followed by 5-fluorouracil/epirubicin/cyclophosphamide (P-FEC) in human breast cancers.

Tumor Samples

GSE32646

Summary

The purpose of the present study was to investigate the association of glutathione S-transferase P1 (GSTP1) expression with resistance to neoadjuvant paclitaxel followed by 5-fluorouracil/epirubicin/cyclophosphamide (P-FEC) in human breast cancers. The relationship of GSTP1 expression and GSTP1 promoter hypermethylation with intrinsic subtypes was also investigated. In this study, primary breast cancer patients (n=123, stage treated with neoadjuvant P-FEC were analyzed.

Tumor samples were obtained by vacuum-assisted core biopsy before P-FEC. GSTP1 expression was determined using immunohistochemistry, GSTP1 promoter methylation index (MI) using bisulfite methylation assay and intrinsic subtypes using DNA microarray. The pathological complete response (pCR) rate was significantly higher in GSTP1-negative tumors (80.0%) than GSTP1-positive tumors (30.6%) (P=0.009) among estrogen receptor (ER)-negative tumors but not among ER-positive tumors (P=0.267). Multivariate analysis showed that GSTP1 was the only predictive factor for pCR (P=0.013) among ER-negative tumors. Luminal A, luminal B and HER2-enriched tumors showed a significantly lower GSTP1 positivity than basal-like tumors (P=0.002, P<0.001 and P=0.009, respectively), while luminal A, luminal B and HER2-enriched tumors showed a higher GSTP1 MI than basal-like tumors (P=0.076, P<0.001 and P<0.001, respectively).

In conclusion, these results suggest the possibility that GSTP1 expression can predict pathological response to P-FEC in ER-negative tumors but not in ER-positive tumors. Additionally, GSTP1 promoter hypermethylation might be implicated more importantly in the pathogenesis of luminal A, luminal B and HER2-enriched tumors than basal-like tumors (see Table 1).

Overall Design

Fresh frozen tumor samples obtained by vacuum-assisted core biopsy from one hundred and fifteen patients were subjected to RNA extraction and hybridization on Affymetrix microarrays.

### Example 2

Expression data from breast cancer FNA biopsies on response to cyclophosphamide (FEC) followed by four cycles of docetaxel/capecitabine,her2+

GSE42822

Summary

Tumor samples were obtained from patients with stage II-III breast cancer before starting neoadjuvant chemotherapy with four cycles of 5-fluorouracil/epirubicin/cyclophosphamide (FEC) followed by four cycles of docetaxel/capecitabine (TX) on US Oncology clinical trial 02-103. Most patients with HER-2-positive cancer also received trastuzumab (H).

Overall Design

Pre-treatment FNA from primary tumors were obtained and RNA extracted and hybridized to affymetrix microarrays according to manufacturer protocol (see Table 1).

### Example 3

Expression data from breast cancer FNA biopsies on response to 5-fluorouracil, doxorubicin and cyclophosphamide followed by 4 additional courses of weekly docetaxel and capecitabine.

GSE23988

Summary

This is Phase II Trial of 4 courses of 5-fluorouracil, doxorubicin and cyclophosphamide followed by 4 additional courses of weekly docetaxel and capecitabine administered as Preoperative Therapy for Patients with Locally Advanced Breast Cancer, Stages II and III by US oncology (PROTOCOL 02-103) 2 5 Gene set analysis (GSA) was performed using functionally annotated gene sets corresponding to almost all known biological processes in ER-positive/HER2negative and ER-negative/HER2-negative breast cancer, respectively.

Overall Design

Pre-treatment FNA from primary tumors were obtained and RNA extracted and hybridized to afymetrix microarrays according to manufacturer protocol (see Table 1).

Normal samples:-GSE42568

### Example 4

Expression data from 104 breast cancer biopsies

Summary

Analysis of 104 breast cancer biopsies (removed prior to any treatment with tamoxifen or chemotherapeutic agents) from patients aged between 31 years and 89 years at the time of diagnosis (mean age=58 years). Twenty were less than 50 years and seventy-seven women were 50 years, or older, at diagnosis. The size of the tumours ranged between 0.6 cm and 8.0 cm (mean=2.79 cm). Eighteen tumours were T1 (<2 cm) in maximal dimension; 83 were T2 (2-5 cm) and 3 tumours were T3 (>5 cm). Eighty-two were invasive ductal carcinoma, 17 were invasive lobular and five were tumours of special type (two tubular and three mucinous). Eleven tumours were grade 1; 40 were grade 2; and 53 were grade 3. Sixty-seven tumours were oestrogen receptor (ER) positive and 34 were ER negative (ER status was determined by Enzyme Immuno-Assay (EIA); a positive result was defined as more than 200 fmol/g protein). ER status was not available for 3 patients. Forty-five tumours had no axillary metastases and 59 tumours had metastasised to axillary lymph nodes. Sixty-nine women were treated with post-operative tamoxifen; 26 did not receive tamoxifen. Fifty patients were treated with adjuvant systemic chemotherapy (CMF +/−adriamycin); 45 patients did not receive chemotherapy. Details regarding tamoxifen and systemic chemotherapy were not available for 9 patients. Maximal follow-up was 3,026 days with a mean follow-up of 1,887 days.

17 normal breast tissues were also assayed.

Overall Design

Gene expression profiling of 104 breast cancer and 17 normal breast biopsies.

GSE9574

Summary

Normal-appearing epithelium of cancer patients can harbor occult genetic abnormalities. Data comprehensively comparing gene expression between histologically normal breast epithelium of breast cancer patients and cancer-free controls are limited. The present study compares global gene expression between these groups. Microarrays were performed using RNA from microdissected histologically normal terminal ductal-lobular units (TDLU) from 2 groups: (i) cancer normal (CN) (TDLUs adjacent to untreated ER1 breast cancers (n=14)) and (ii) reduction mammoplasty (RM) (TDLUs of age-matched women without breast disease (n=15)). Cyber-T identified differentially expressed genes. Quantitative RT-PCR (qRT-PCR), immunohistochemistry (IHC), and comparison to independent microarray data including 6 carcinomas in situ (CIS), validated the results. Gene ontology (GO), UniProt and published literature evaluated gene function. About 127 probesets, corresponding to 105 genes, were differentially expressed between CN and RM (p<0.0009, corresponding to FDR<0.10). 104/127 (82%) probesets were also differentially expressed between CIS and RM, nearly always (102/104 (98%)) in the same direction as in CN vs. RM. Two-thirds of the 105 genes were implicated previously in carcinogenesis. Overrepresented functional groups included transcription, G-protein coupled and chemokine receptor activity, the MAPK cascade and immediate early genes. Most genes in these categories were under-expressed in CN vs. RM. It should be concluded that global gene expression abnormalities exist in normal epithelium of breast cancer patients and are also present in early cancers. Thus, cancer-related pathways may be perturbed in normal epithelium. These abnormalities could be markers of disease risk, occult disease, or the tissue's response to an existing tumor.

A summary of analyzed datasets is presented in Table 1.

Overall Design

29 samples from histologically normal microdissected breast epithelium are included in this series. 14 samples are from epithelium adjacent to a breast tumor, 15 samples were obtained from patients undergoing reduction mammoplasty without apparent breast cancer

TABLE 1
GEO datasets description.

| | | | | | Patients | Number |
|---|---|---|---|---|---|---|
| GEO | | | | | (responders/ | of |
| Series | | | Normal | | non- | marker |
| ID | Title | Platform | samples | Anticancer therapy | responders) | pathways |
| GSE32646 | GSTP1 expression | GPL570 | GSE42568 | paclitaxel followed by 5- | 27/88 | 9 |
| | predicts poor | | | fluorouracil/epirubicin/ | | |
| | pathological complete | | | cyclophosphamide | | |
| | response to neoadjuvant | | | | | |
| | chemotherapy in ER- | | | | | |
| | negative breast cancer | | | | | |
| GSE42822 | Expression data from | GPL96 | GSE9574 | fluorouracil/epirubicin/ | 25/41 | 7 |
| | breast cancer FNA | | | cyclophosphamide (FEC) | | |
| | biopsies from patients | | | followed by four cycles of | | |
| | ((USO samples) | | | docetaxel/capecitabine, her2+ | | |
| GSE23988 | Expression data from | GPL96 | GSE9574 | 5-fluorouracil, doxorubicin | 20/41 | 11 |
| | breast cancer FNA | | | and cyclophosphamide | | |
| | biopsies from patients | | | follwed by 4 additional | | |
| | (US samples) | | | courses of weekly docetaxel | | |
| | | | | and capecitabine | | |

Normalized data and OncoFinder PAS values for all signaling pathways are provided in supplementary materials.

Statistics for marker signaling pathways are presented in Table 2. Marker signaling pathways differ in responders in comparison to non-responders.

TABLE 2
Datasets characteristics. For each dataset anticancer therapy is presented. For all marker
signaling pathways mean PAS values and standard deviation (sd) of PAS values are counted
for a group of responders and a group of non-responders to the anticancer therapy

| GEO | | | | | Non- | Non- |
|---|---|---|---|---|---|---|
| Series | Anticancer | | Responders | Responders | responders | responders |
| ID | therapy | Marker pathways | mean | sd | mean | sd |
| GSE23988 | 5-fluorouracil, | AKT Pathway (Protein Synthesis) | −2.51 | 1.03 | −1.84 | 0.85 |
| | doxorubicin and | ATM Pathway (G2 Mitosis Progression) | −3.66 | 1.04 | −2.52 | 1.36 |
| | cyclophosphamide | ATM Pathway (G2/M Checkpoint Arrest) | −5.19 | 1.68 | −3.30 | 2.76 |
| | followed by | ATM Pathway (S-Phase Progression) | −2.07 | 0.86 | −1.33 | 1.01 |
| | 4 additional | Caspase Cascade (Apoptosis) | −8.87 | 2.70 | −6.48 | 3.30 |
| | courses of | DDR pathway Apoptosis | 4.76 | 3.03 | 2.55 | 2.71 |
| | weekly | G-protein Pathway (Ras family GTPases) | 4.78 | 1.59 | 3.28 | 2.03 |
| | docetaxel and | Mismatch Repair Main Pathway | 10.18 | 5.20 | 5.91 | 4.22 |
| | capecitabine | PTEN Main Pathway | −8.99 | 4.19 | −5.81 | 4.13 |
| | | Cell Cycle Pathway (Origin of S-phase) | 11.12 | 7.26 | 4.64 | 5.51 |
| | | Cell Cycle Pathway (End of S-phase) | 4.72 | 3.02 | 2.10 | 2.66 |
| GSE42822 | fluorouracil/ | AKT Pathway (Protein Synthesis) | −2.44 | 0.99 | −1.77 | 0.78 |
| | epirubicin/ | ATM Pathway (G2 Mitosis Progression) | −3.53 | 0.93 | −2.58 | 1.28 |
| | cyclophosphamide | ATM Pathway (G2/M Checkpoint Arrest) | −5.09 | 1.75 | −3.36 | 2.75 |
| | (FEC) followed by | ATM Pathway (S-Phase Progression) | −1.93 | 0.80 | −1.27 | 0.98 |
| | four cycles of | DDR pathway Apoptosis | 4.66 | 2.73 | 2.97 | 2.49 |
| | docetaxel/ | HIF1-Alpha Main Pathway | 13.16 | 4.82 | 9.96 | 3.07 |
| | capecitabine | Cell Cycle Pathway (Origin of S-phase) | 9.65 | 6.81 | 4.91 | 4.82 |
| GSE32646 | paclitaxel | DDR Pathway (BRCA1-induced responses) | 5.80 | 2.93 | 3.16 | 3.44 |
| | followed by | Chemokine Main Pathway | 38.47 | 8.38 | 30.20 | 8.40 |
| | 5-fluorouracil/ | Chemokine Pathway (Internalization | 3.40 | 1.72 | 2.39 | 1.45 |
| | epirubicin/ | Degradation Recycling) | | | | |
| | cyclophosphamide | Fas Signaling Pathway (Negative) | 17.43 | 2.49 | 15.47 | 3.61 |
| | | Glucocorticoid Receptor Main Pathway | 64.05 | 13.08 | 53.80 | 10.07 |
| | | IL-2 Main Pathway | 45.43 | 12.67 | 36.78 | 9.30 |
| | | PTEN Main Pathway | −21.18 | 3.39 | −18.82 | 3.97 |
| | | STAT3 Main Pathway | 52.75 | 20.87 | 39.58 | 14.97 |

Prediction System

Cross validation was performed to estimate the accuracy of prediction power of ResponseScore value for 15 therapies.

The following was done for all samples in analyzed datasets:

Each sample was excluded out of analysis one by one; the rest were analyzed as described in data preparation and analysis section. Thus, all samples were predicted to be a responder or non-responder. Given the datasets information (real clinical outcomes) it is easy to detect the accuracy of the prediction system for particular anticancer therapy (Table 3 and Table 4).

TABLE 3
Results of BreastCancerTreatment module's ability to
predict the clinical outcome of patients with the use
of signaling pathways

| GEO Series | | | |
|---|---|---|---|
| ID | Anticancer therapy | AUC | Accuracy |
| GSE23988 | 5-fluorouracil, doxorubicin and | 0.79 | 0.72 |
| | cyclophosphamide follwed by 4 | | |
| | additional courses of weekly | | |
| | docetaxel and capecitabine | | |
| GSE32646 | paclitaxel followed by 5- | 0.78 | 0.69 |
| | fluorouracil/epirubicin/ | | |
| | cyclophosphamide | | |
| GSE42822 | fluorouracil/epirubicin/cyclopho- | 0.73 | 0.69 |
| | sphamide (FEC) followed by four | | |
| | cycles of docetaxel/capecitabine | | |

TABLE 4
Results of BreastCancerTreatment module's ability to
predict the clinical outcome of patients with the use
of signaling and metabolic pathways

| GEO Series | | | |
|---|---|---|---|
| ID | Anticancer therapy | AUC | Accuracy |
| GSE23988 | 5-fluorouracil, doxorubicin and | 0.83 | 0.73 |
| | cyclophosphamide follwed by 4 | | |
| | additional courses of weekly | | |
| | docetaxel and capecitabine | | |
| GSE32646 | paclitaxel followed by 5- | 0.73 | 0.81 |
| | fluorouracil/epirubicin/ | | |
| | cyclophosphamide | | |
| GSE42822 | fluorouracil/epirubicin/cyclopho- | 0.81 | 0.74 |
| | sphamide (FEC) followed by four | | |
| | cycles of docetaxel/capecitabine | | |

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A method for predicting a clinical outcome of a patient having a disorder, the method comprising:
a) providing a drug score database (DSD) based on pathway activation strengths (PASs) for a plurality of biological pathways associated with the drug in the treatment of the disorder; and
b) comparing said pathway activation strengths of said plurality of biological pathways of said patient with said drug score database to provide a predictive indication if said patient is a responder or non-responder to said drug;
c) repeating steps a) and b) for a plurality of drugs thereby predicting a clinical outcome to said plurality of drugs of said patient to said disorder.

2. A method according to claim 1, wherein said providing a drug score database (DSD) step comprises:
a) obtaining proliferative bodily samples and healthy bodily samples from patients;
b) applying said drug to said patients;
c) determining responder and non-responder patients to said drug; and
d) repeating steps i to iii for said plurality of drugs.

3. A method according to claim 2, wherein said determining step comprises comparing gene expression in at least one of a signaling pathway and a metabolic pathway.

4. A method according to claim 3, wherein said at least one of a signaling pathway and said metabolic pathway is associated with said drug.

5. A method according to claim 2, wherein said determining step further comprises determining a drug score at least one pathway activation strength (PAS) value for each pathway in said responder and said non-responder patients.

6. A method according to claim 5, wherein said determining step further comprises determining a drug score for said drug based on said at least one pathway activation strength (PAS) value.

7. A method according to claim 2, wherein said bodily samples are selected from the group consisting of a tissue sample, a cell culture, an individual single cell, a bodily sample, an organism sample and a microorganism sample.

8. A method according to claim 1, wherein said biological pathways are signaling pathways.

9. A method according to claim 1, wherein said biological pathways are metabolic pathways.

10. A method according to claim 3, wherein said gene expression comprises quantifying expression of plurality of gene products.

11. A method according to claim 10, wherein said gene products comprises a set of at least five gene products.

12. A method according to claim 12, wherein said calculating step comprises adding concentrations of said set of said at least five gene products of said sample and comparing to a same set in said at least one control sample.

13. A method according to claim 13, wherein said gene products provide at least one function in said biological pathway.

14. A method according to claim 13, wherein said at least one function comprises an activation function and a suppressor function.

15. A method according to claim 14, wherein said at least one function comprises an up-regulating function and a down-regulating function.

16. A method according to claim 2, wherein said determining step comprises at least one of profiling gene expression, RNA profiling, RNA sequencing, DNA profiling, DNA sequencing, protein profiling, amino acid sequencing, at least one immunochemical methodology, a mass spectrometry analysis, a microarray technology, a quantitative PCR methodology and combinations thereof.

17. A method according to claim 19, wherein said sick subject suffers from a proliferative disease or disorder.

18. A method according to claim 1, wherein said pathway is selected from the group consisting of a Caspase Cascade pathway; a CREB pathway; a GPCR pathway; a CSK3 pathway; an HIF1Alpha pathway; an HIF1Alpha Pathway VEGF pathway; an ILK pathway; an IP3 pathway; a PPAR pathway; a VEGF pathway; and combinations thereof.

19. A computer software product, said product configured for predicting a clinical outcome of a patient having a disorder, the product comprising a computer-readable medium in which program instructions are stored, which instructions, when read by a computer, cause the computer to:
a) provide a drug score database (DSD) based on pathway activation strengths (PASs) for a plurality of biological pathways associated with the drug in the treatment of the disorder; and
b) compare said pathway activation strengths of said plurality of biological pathways of said patient with said drug score database to provide a predictive indication if said patient is a responder or non-responder to said drug;
c) repeat steps i) and ii) for a plurality of drugs thereby predicting a clinical outcome to said plurality of drugs of said patient to said disorder.

20. A system for predicting drug efficacy for treating a disorder in a patient the system comprising:
a. a processor adapted to activate a computer-readable medium in which program instructions are stored, which instructions, when read by a computer, cause the processor to:
i. provide a drug score database (DSD) based on pathway activation strengths (PASs) for a plurality of biological pathways associated with the drug in the treatment of the disorder; and
ii. compare said pathway activation strengths of said plurality of biological pathways of said patient with said drug score database to provide a predictive indication if said patient is a responder or non-responder to said drug;
iii. repeat steps i) and ii) for a plurality of drugs thereby predicting a clinical outcome to said plurality of drugs of said patient to said disorder;
b. a memory for storing said drug score database (DSD); and
c. a display for displaying data associated with said predictive clinical outcome of said patient.
